(19) United States
(12) Patent Application Publication
(10) Pub. No.: US 2004/0158946 A1
(43) Pub. Date: Aug. 19, 2004

(54) Fitting and tubing end cleaning and deburring tool

(76) Inventor: Mark A. Monson, Lake Lure, NC (US)

Correspondence Address: STEVEN C. SCHNEDLER, CARTER SCHNEDLER & MONTEITH, PA, 56 CENTRAL AVE., SUITE 101, PO BOX 2985, ASHEVILLE, NC, 28802, US

(21) Appl. No.: 10/775,842

(22) Filed: Feb. 9, 2004

Related U.S. Application Data
(60) Provisional application No. 60/447,926, filed on Feb. 19, 2003.

(51) Int. Cl. B08B 9/00

(52) U.S. Cl. 15/104.04; 15/104.2; 15/106

(57) ABSTRACT

A hand held tool for cleaning or scarifying an inner cylindrical surface of a fitting and an outer cylindrical surface of a tubing end. The tool includes a body having first and second scarifying portions interconnected by an intermediate portion, as well as front and rear sides. Each of the scarifying portions has a respective inner surface scarifying brush projecting from the front side for cleaning a fitting, and a cylindrical recess within the front side supporting a respective outer surface scarifying brush for cleaning a tubing end. During use, the tool is held by the handle in one hand, and the fitting or tubing is held in the other hand to engage the appropriate scarifying bush. The handle is rotated in the manner of a hand crank.

### CROSS-REFERENCE TO RELATED APPLICATION

The benefit of provisional application Serial No. 60/447,926, filed Feb. 19, 2003 is claimed.

### BACKGROUND OF THE INVENTION

The invention relates to tools for cleaning or scarifying fittings and tubing ends, particularly copper fittings and copper tubing, in preparation for soldering.

To prepare copper fittings and copper tubing for soldering, oxidation must be removed from surfaces to be soldered, and the surfaces scratched, a process which is commonly referred to as cleaning, and which may also be termed scarifying. A common tool for cleaning or scarifying the inner cylindrical surface of a fitting is a fitting brush which generally takes the form of a cylindrical wire brush secured to a shaft-like spine with an attached straight handle. The cylindrical wire brush fits tightly inside the fitting, and is rotated by hand, primarily by wrist action. Fitting brushes are available sized for corresponding fitting sizes. The most popular fitting sizes for residential plumbing are 1/2 inch and 3/4 inch.

Use of such a tool requires twisting the wrist over and over to rotate the brush in the fitting. As a result, the user's wrist can get sore and tired. The cleaning or scarifying operation additionally is relatively time-consuming.

Correspondingly for cleaning or scarifying the outer cylindrical surface of a tubing end, tube cleaning brushes are available which take the form of a cylindrical shell defining a cylindrical cavity. Wire bristles extend generally radially inwardly from the cylindrical shell and serve to clean or scarify the outer cylindrical surface of a tubing end inserted into the cavity as the brush is rotated. The brush is mounted within a suitable holder which can be held in the hand for rotating the brush, again by wrist action.

Fitting brushes and tube cleaning brushes of the types generally described above are also available in configurations which can be driven by a power tool, such as an electric drill motor, thus avoiding the need for wrist action. This however is at the expense of requiring an additional element, in particular, the drill motor.

Several hand held combination tools for cleaning or scarifying fittings and tubing ends are commercially available. Examples are provided by the disclosures of Litt U.S. Pat. No. 4,133,070; Grabowski et al U.S. Pat. No. 5,791,005 and Yehia U.S. Pat. No. 6,578,228. In addition, hand held swivel blade deburring tools are available from Noga Engineering Ltd., Israel (www.noga.com).

### SUMMARY OF THE INVENTION

In one aspect, the invention is embodied in a hand held tool for cleaning or scarifying an inner cylindrical surface of a fitting and an outer cylindrical surface of a tubing end. The tool includes a body having a front side, a rear side, and first and second scarifying portions. Each of the scarifying portions has a respective inner surface scarifying brush projecting from the front side, as well as a cylindrical recess within the front side supporting a respective outer surface scarifying brush. A handle is rotatably attached to the intermediate portion and projects from the rear side. The handle has a rotational axis generally perpendicular to the rear side.

In another aspect, the invention is embodied in a hand held tool for scarifying an inner cylindrical surface of a fitting and an outer cylindrical surface of a tubing end. The tool includes a body having a front side, a rear side, and first and second scarifying portions. Each of the scarifying portions has a respective inner surface scarifying brush projecting from the front side. Each of the scarifying portions also has a cylindrical recess within a respective portion of the front side supporting a respective outer surface scarifying brush. The scarifying brushes have axes which are parallel to each other. A handle is rotatably attached to the body and projects from the rear side. The handle has a rotational axis lying in a first rotational axis plane which is intermediate the inner surface scarifying brushes, perpendicular to a line between the axes of the inner surface scarifying brushes and parallel to the axes of the inner surface scarifying brushes. The rotational axis of the handle also lies in a second rotational axis plane which is intermediate the outer surface scarifying brushes, perpendicular to a line between the outer surface scarifying brushes, and parallel to the central axes of the outer surface scarifying brushes.

In yet another aspect, the invention is embodied in a hand held tool for cleaning or scarifying an inner cylindrical surface of a fitting. The tool includes a body having a front side and a rear side, and first and second scarifying portions interconnected by an intermediate portion. Each of the scarifying portions has a respective inner surface scarifying brush projecting from the front side. A handle is rotatably attached to the intermediate portion and projects from the rear side. The handle has a rotational axis generally perpendicular to the rear side.

In still another aspect, the invention is embodied in a hand held tool for cleaning or scarifying an outer cylindrical surface of a tubing end. The tool includes a body having a front side and a rear side, and first and second scarifying portions interconnected by an intermediate portion. Each of the scarifying portions has a cylindrical recess within the front side supporting a respective outer surface scarifying brush. A handle is rotatably attached to the intermediate portion and projects from the rear side. The handle has a rotational axis generally perpendicular to the rear side.

### BRIEF DESCRIPTION OF THE DRAWINGS

FIG. 1 is a three-dimensional view, generally from the front thereof, of a hand held scarifying and deburring tool embodying the invention;

FIG. 2 is a front elevational view of the tool of FIG. 1;

FIG. 3 is a rear elevational view of the tool of FIG. 1;

FIG. 4 is a bottom plan view, taken on line 4-4 of FIG. 2;

FIG. 5 is a view similar to FIG. 4, but with the handle shown in cross-section, and further depicting a piece which serves as a combination deburring blade and mounting post for the handle;

FIG. 6 shows the tool in use scarifying or cleaning the inner cylindrical surface of a fitting;

FIG. 7 similarly shows the tool in use scarifying or cleaning the outer cylindrical surface of a tubing end;

FIG. 8 is an exploded three-dimensional view of the tool, generally in the same orientation as FIG. 1, showing internal details thereof;

FIG. 9 is a view of the piece which serves as the combination deburring blade and post for the handle in isolation, together with an attachment nut, viewed generally from the right side in the orientation of FIGS. 4 and 5, as indicated by view line 9-9 in FIG. 5;

FIG. 10 is a similar view of the piece of FIG. 9 and the attachment nut, however viewed generally from the left side in the orientation of FIGS. 4 and 5, as indicated by view line 10-10 in FIG. 5;

FIG. 11 is a view of the piece of FIG. 9 and attachment nut, in the same orientation as in FIGS. 4 and 5, which is also the orientation indicated by view line 11-11 in FIG. 2; and

FIG. 12 is an enlarged view of the deburring blade, partly in cross-section, taken on line 12-12 of FIG. 11.

### DETAILED DESCRIPTION

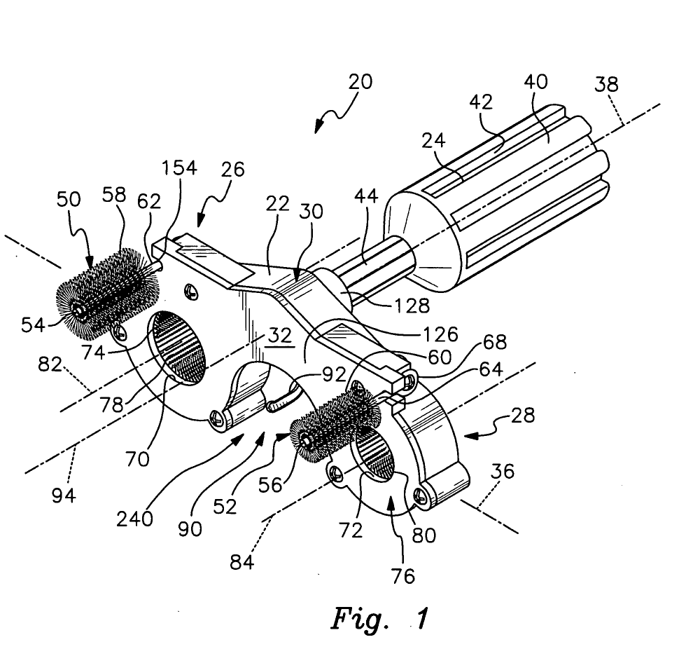

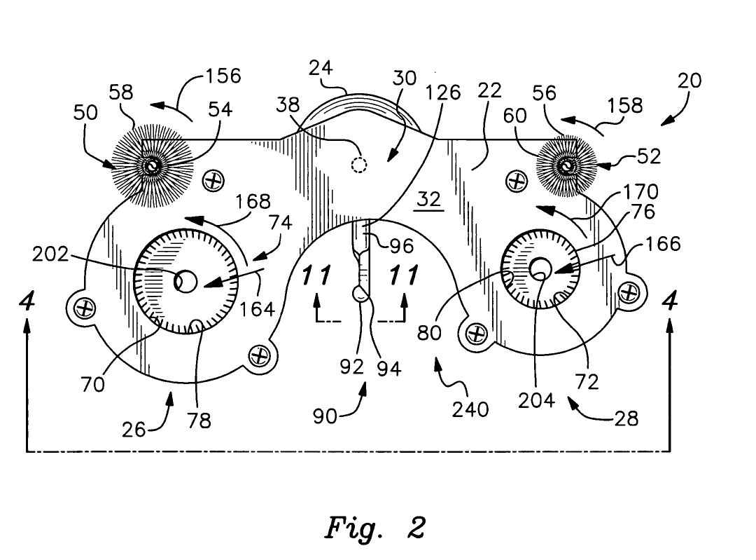

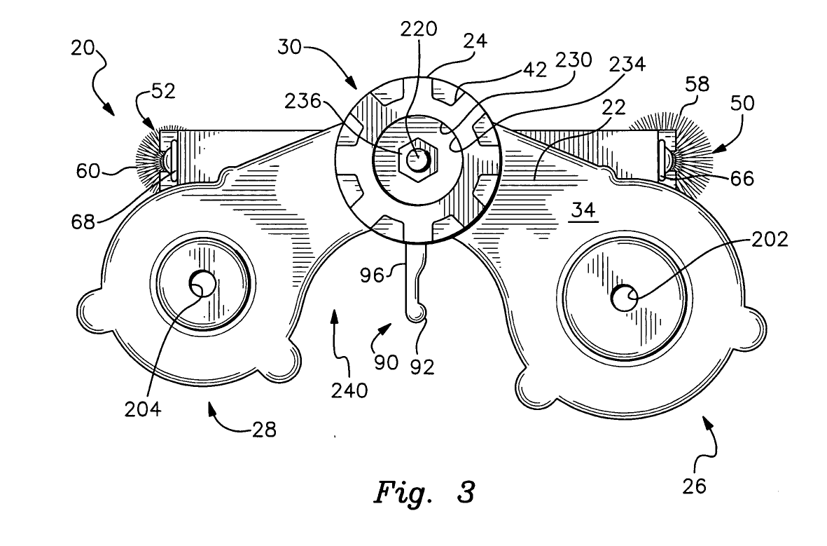

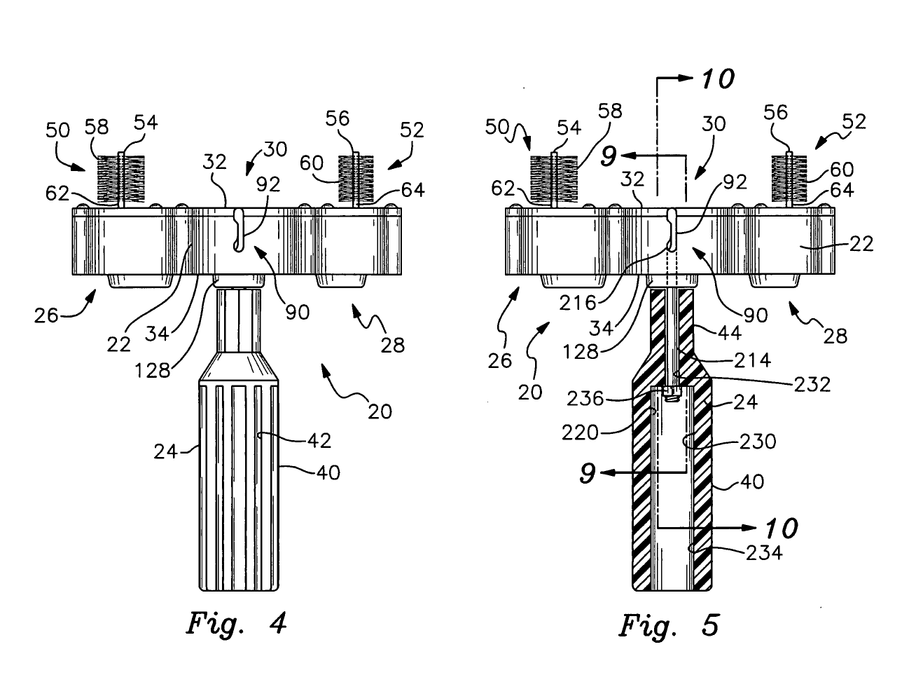

Referring first to FIGS. 1-4, a hand held scarifying tool 20 includes an elongated body 22 and a handle 24 rotatably attached to the body 22, generally at a right angle thereto. The longitudinal body 22 may also be viewed as a cross-bar. The body 22 more particularly has first and second scarifying portions generally designated 26 and 28, interconnected by an intermediate portion 30. The body 22 has a front side 32 visible in FIGS. 1 and 2, and a rear side 34 visible in FIG. 3 and from which the handle 24 projects. The elongated body 22 has a body axis 36 extending generally through the scarifying portions 26 and 28.

In the illustrated embodiment, the handle 24 more particularly is rotatably attached to the intermediate portion 30 of the body 22 and has a rotational axis 38 generally perpendicular to the rear side 34 of the body 22. Also, the rotational axis 38 of the handle 24 lies in a plane perpendicular to the body axis 36. The handle 24 is a straight handle, and is sized so that it can be positioned across the palm of a user's hand, and firmly gripped. The handle 24 has a relatively larger diameter cylindrical grip portion 40 with longitudinal flutes 42 to aid in gripping, as well as a relatively smaller diameter cylindrical transition portion 44.

The scarifying portions 26 and 28 have respective inner surface scarifying brushes 50 and 52 projecting from the front side 32. The inner surface scarifying brushes 50 and 52 are of the same general construction as the brush end of a conventional fitting brush, and are of two different diameters sized for cleaning fitting portions of two different diameters, respectively. As an example, the scarifying brush 50, which has a relatively larger diameter, is sized for cleaning 3/4 inch copper fittings. The inner surface scarifying brush 52 has a relatively smaller diameter and is sized for cleaning 1/2 inch copper fittings.

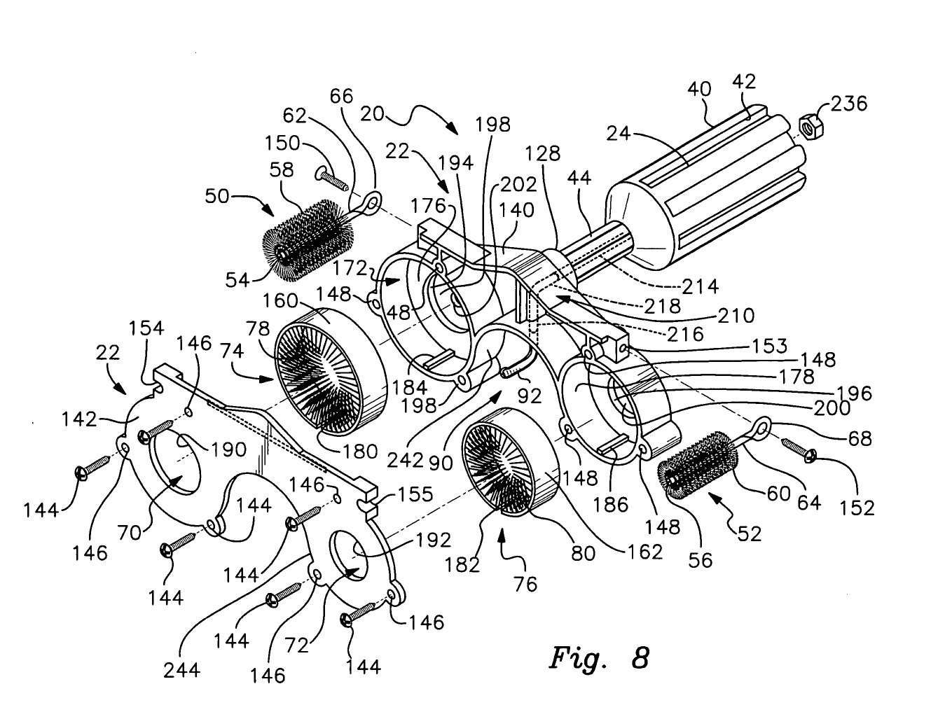

The inner surface scarifying brushes 50 and 52 are of conventional construction, and include elongated central twisted wire spines 54 and 56 having wire bristles 58 and 60 secured thereto. The twisted wire spines 54 and 56 additionally have mounting portions 62 and 64 which are free of bristles. As shown in FIG. 8, described hereinbelow, the mounting portions 62 and 64 terminate in mounting eyelets 66 and 68. The twisted wire spines 54 and 56 define respective axes of the inner surface scarifying brushes 50 and 52, which axes are parallel to each other.

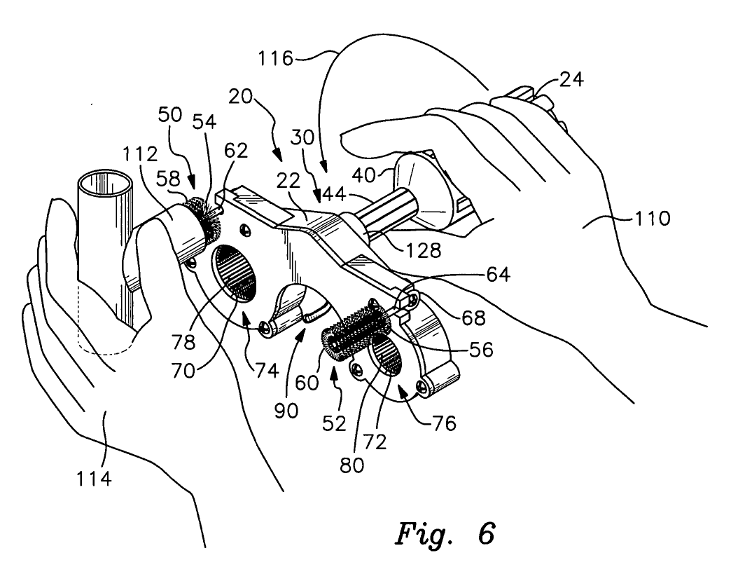

A characteristic of this construction is that the handle axis 38 is offset from the axis of each of the inner surface scarifying brushes 50 and 52; which enables the cranking action during use described hereinbelow with reference to FIG. 6.

The scarifying portions 26 and 28 also have respective cylindrical recesses 70 and 72 within the front side 32 supporting respective outer surface scarifying brushes 74 and 76, of the same general construction as conventional tube cleaning brushes. The scarifying brushes 74 and 76 have wire bristles 78 and 80 which extend generally radially inwardly. The outer surface scarifying brush 74 has a relatively larger diameter, and is sized for cleaning the outer surface of 3/4 inch copper tubing, for example. The outer surface scarifying brush 76 is of relatively smaller diameter, and is sized for cleaning the outer surface of 1/2 inch tubing. The brushes 74 and 76 have respective central axes 82 and 84 (FIG. 1) which are parallel to each other, as well as to the axes of the brushes 50 and 52 defined by the spines 54 and 56.

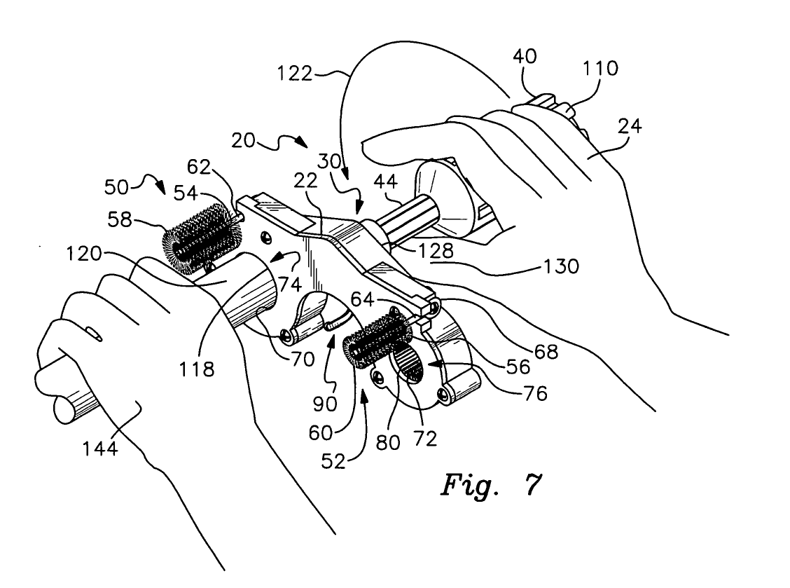

Again, a characteristic of this construction is that the handle axis 38 is offset from the central axes 82 and 84 of the outer surface scarifying brushes 74 and 76, enabling the cranking action during use described hereinbelow with reference to FIG. 7.

Geometrically, the axis 38 of the handle 24 lies in a first rotational axis plane which is intermediate the inner surface scarifying brushes 50 and 52, perpendicular to a line between the inner surface scarifying brushes 50 and 52, and parallel to the axes of the inner surface scarifying brushes defined by the twisted wire spines 54 and 56. The handle 24 axis 38 also lies in a second rotational axis plane which is intermediate the outer surface scarifying brushes 74 and 76, perpendicular to a line between the outer surface scarifying brushes, and parallel to the central axes 82 and 84 of the outer surface scarifying brushes 74 and 76. In the illustrated embodiment, these first and second rotational axis planes are substantially coincident.

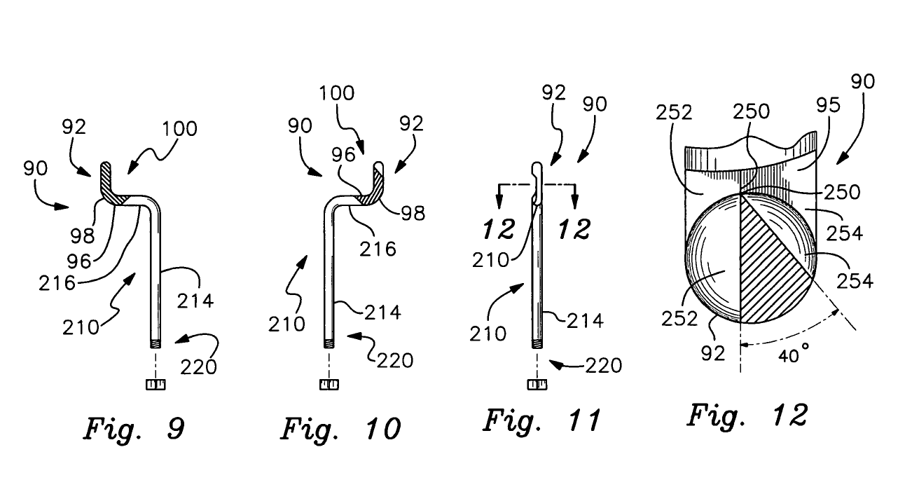

In addition to the scarifying brushes 50, 52 and 74, 76, the tool includes s deburring blade 90 attached to the body 22 in the manner described hereinbelow with particular reference to FIG. 8, and shown in greater detail in FIGS. 9-12, also described hereinbelow. Briefly, the deburring blade 90 includes a projecting portion 92 on a deburring blade axis 94 which is generally parallel to but spaced from the rotational axis 38 of the handle 24, as well as a rear segment 96 joined at right angles by a curved transition segment 98. The deburring blade 90 has an active portion 100 which curves from the projecting portion 92 around the transition segment 98 to the rear segment 96.

Referring now to FIGS. 6 and 7, during use of the tool 22 as thus far described, the handle 24 is grasped in the right hand 110 of a user. With particular reference to FIG. 6, for cleaning or scarifying the inner surface of a representative fitting 112, the fitting 112 is held in the left hand 114 of the user, and the appropriately-sized one of the inner surface scarifying brushes 50 and 52, in the illustrated example the relatively larger brush 50, is inserted into the fitting 112. As indicated by arrow 116, the user then rotates the handle 24 or, more particularly, the axis 38 of the handle 24, around or relative to the fitting 112 in the manner of turning a crank. Accordingly, the brush 50 rotates inside the fitting 112, cleaning the inner surface thereof. This cranking action is much easier compared to the wrist action required with a simple tubing brush. Moreover, because the handle 24 rotates with reference to the body 22, the right hand 110 of the user can hold the handle 24 with a fixed grip.

In a similar manner, and with particular reference to FIG. 7, for cleaning or scarifying the outer surface at the end 118 of a piece of tubing 120, the handle 24 is again held in the right hand 110 of the user, and the tubing end 118 is inserted into one of the outer surface scarifying brushes 74 and 76, in this particular example into the relatively larger diameter outer surface scarifying brush 74. Again, as indicated by rotational arrow 122, the handle 24 or, more particularly, the handle axis 38, is rotated around or relative to the tubing 120 in the manner of a hand crank.

A feature of the tool 20 is that it includes scarifying brushes for two different sizes of fittings and tubing again, in the illustrated example, for 1/2 inch and 3/4 inch copper fittings and tubing. Related to that is the manner in which the body 22 of the tool 20 orients or balances itself by gravity always in the same orientation. An advantage of this is, once a user learns this orientation, given a particular size fitting or tubing end (1/2 inch or 3/4 inch), the user can quickly select and find the appropriate brushes to use, either the relatively larger brushes 50 and 74 of the relatively larger diameter portion 26 of the body 22, or the relatively smaller brushes 52 and 76 of the relatively smaller diameter portion 28 of the body 22.

More particularly, the body 22 has a center of gravity 126 (FIGS. 1 and 2) which is approximately midway between the scarifying portions 26 and 28. The rotational axis 38 of the handle 24 is offset from the center of gravity 126 in a direction perpendicular to the body axis 36. Accordingly, when the tool 20 is grasped by the handle 24 with the handle axis 38 generally horizontal, the body 22 rotates by gravity to an orientation in which the body axis 36 is approximately horizontal. As a result, when the tool 20 is picked up by the handle 24, the two scarifying portions 26 and 28 are always in the same orientation with reference to each other and to the handle 24, obviating the need for the user to visually determine the positions of the relatively larger diameter body portion 26 and the relatively smaller diameter body portion 28.

Related to that, to serve as a stabilizing brake against rotation of the body 22 relative to the handle 24 when one of the inner surface scarifying brushes 50, 52 is inserted into a fitting, such as the fitting 112, or when a tubing end, such as the tubing end 118, is inserted into one of the outer surface scarifying brushes 74, 76, a cylindrical boss 128 is provided on the rear side 34 of the body 22, coaxial with the rotational axis 38 of the handle 24. Thus, during use, the tool 20 is picked up by the handle 24 and the body 22 is allowed to stabilize by gravity in the horizontal position illustrated in FIGS. 1-3, 6 and 7. At this point, the right thumb 130 of the user contacts the cylindrical boss 128 to stabilize the position of the body 22 relative to the handle 24 until the fitting 112 or tubing end 118 is applied to the appropriate brush. The thumb 130 of the user is then released from the cylindrical boss 128, and cranking commences as described hereinabove with reference to FIGS. 6 and 7.

FIG. 8 is an exploded three-dimensional view of the tool 20, showing the manner of construction and internal details thereof. The body 22 generally comprises a main cavity portion 140 and a cover plate 142, both made of injection-molded plastic. The cover plate 142 is secured to the main cavity portion 140 by screws 144 which pass through apertures 146 in the cover plate 142 and engage holes 148.

The inner surface scarifying brushes 50 and 52 are attached to the main cavity portion 140 of the body 22 by screws 150 and 152 which pass through the eyelets 66 and 68 and engage holes such as the hole 153 visible in FIG. 8 in the main cavity portion 140. The cover plate 142 has a pair of U-notches 154 and 155 through which the mounting portions 62 and 64 pass such that, in effect, the inner surface scarifying brushes 50 and 52 project from the front side 32 of the body 22 when assembled. The twist of the wire spines 54 and 56 is such that there is an intended direction of rotation which tends to keep the wire bristles 58 and 60 tightly secured during use. This direction of rotation is indicated in FIG. 2 by arrows 156 and 158 showing counterclockwise rotation in the orientation of FIG. 2 of the body 22 and brushes 50 and 52 with reference to the fitting 112 (FIG. 6) as cranking action occurs as indicated by arrow 116 in FIG. 6. Brushes suitable for use as the inner surface scarifying brushes 50 and 52 are “single stem” brushes sold as replacement brushes for a product known as the “Four-in One Brush” from Mill-Rose, and marked with U.S. Pat. No. 4,038,715 in Mill-Rose promotional materials.

The outer surface scarifying brushes 74 and 76 include respective outer cylindrical rings 160 and 162 from which the bristles 78 and 80 project generally radially inwardly. However, so that the brushes 74 and 76 last longer, as indicated in FIG. 2 by the non-radial arrows 164 and 166 the wire bristles 78 and 80 are angled with reference to radial lines. The intended direction of rotation is indicated by arrows 168 and 170 showing counterclockwise rotation in the orientation of FIG. 2 of the body 22 and brushes 74 and 76 with reference to the tubing 120 (FIG. 7) as cranking action occurs as indicated by arrow 122 in FIG. 7. The outer surface scarifying brushes 74 and 76, in particular the outer cylindrical rings 160, 162 and the bristles 78, 80 are made of a stock material called card clothing, available from some of the same manufacturers which make card clothing for textile mills.

The outer cylindrical rings 160 and 162 are received within respective cylindrical cavities 172 and 174 formed in the main cavity portion 140. The cavities 172 and 174 have respective end walls 176 and 178 molded as part of the main cavity portion 140 of the body 22. The outer cylindrical rings 160 and 162 are held within the cavities 172 and 174 by the cover plate 142 when assembled and accordingly are sandwiched between the cover plates 142 and the end walls 176, 178. To prevent rotation of the outer surface scarifying brushes 74 and 76 relative to the body 22 during operation, the outer cylindrical rings 160 and 162 are split, and thus have respective longitudinal gaps 180 and 182 which engage respective ridges 184 and 186 within the cavities 172 and 174.

For properly guiding tubing ends, such as the representative tubing end 118 in FIG. 7, into the outer surface scarifying brushes 74 and 76, the cover plate 142 has a pair of circular apertures 190 and 192 sized so that tubing 120 passes loosely through, and the cavity end walls 176 and 178 have formed therein respective circular recesses 194 and 196 of the same diameter as the corresponding aperture 190 or 192 in the cover plate 142. The circular recesses 194 and 196 in turn have respective end walls 198 and 200 which limit the insertion depth of a tubing end 118. As may be seen in FIG. 3, to allow debris to fall out, the end walls 198 and 200 have central apertures 202 and 204.

Molded into the main cavity portion 140 during the injection molding process is a bent metal piece 210, respective ends of which comprise the projecting portion 92 of the deburring blade 90 and a mounting post 214 for the handle 24, with a connecting segment 216 between the deburring blade 90 projecting portion 92 and the handle 24 mounting post 214. A portion of the connecting segment 216 comprises the rear segment 96 of the deburring blade 90. As indicated by dash lines in FIGS. 5 and 8, a portion 218 of the piece 210 is entirely encased within the main cavity portion 140, while the deburring blade 90 and the handle 24 mounting post 214 project. The mounting post 214 has a threaded end 220.

As is perhaps best seen in FIG. 5, the handle 24 has a longitudinal bore 230 coaxial with the rotational axis 38 and extending through the entire length of the handle 24. The longitudinal bore 230 has a relatively smaller diameter portion 232 which is sized to fit around the mounting post 214 with sufficient clearance to permit rotation of the handle 24 relative to the mounting post 214, as well as a relatively larger diameter portion 234 which is sized to clear a socket wrench (not shown) used for attaching a retaining nut 236 to the threaded end 220 of the mounting post 214. The retaining nut 236 is a self-locking nut and includes a plastic insert (not shown) to serve the self-locking function in a conventional manner.

The mounting post 214 projects from the rear side 34 of the body 22, more particularly from the rear of the main cavity portion 140, coaxially with the rotational axis 38 of the handle, and centered within the cylindrical boss 128 which serves as a thumb brake. As noted hereinabove, the deburring blade 90 axis 94 is generally parallel to but spaced from the rotational axis 38 of the handle 24. The deburring blade axis 90 is offset from the rotational axis 38 by the length of the connecting segment 216 of the piece 210.

To provide clearance for a tubing end, such as the tubing end 118, during a deburring operation, the intermediate portion 30 of the body 22 has a generally semi-cylindrical deburring recess 240 comprising recess portions 242 and 244 formed in the main cavity portion 140 and the cover plate 142, respectively. As is perhaps best seen in FIG. 2, the deburring blade 90 axis 94 is approximately midway between the outer surface scarifying brushes 74 and 76, and approximately centered within the semi-cylindrical deburring recess 240.

The configuration of the deburring blade 90 is shown more particularly in the views of FIGS. 9, 10 and 11, in the greatly enlarged cross-sectional view of FIG. 12, as well as in the front and rear elevational views of FIGS. 2 and 3. The active portion 100 of the deburring blade 90 curves from the projecting portion 92 around the transition segment 98 to the rear segment 96, and comprises a knife edge 250 defined by two ground surfaces 252 and 254 meeting at a 40° angle.

Use of the deburring blade 90 is similar to use of the scarifying brushes 50, 52 and 74, 76 described hereinabove with reference to FIGS. 6 and 7. In particular, the tool 20 is grasped by the handle 24, and the body 22 is allowed to come to rest by gravity in an approximately horizontal position. The deburring blade 90 accordingly is located in a position familiar to the user with reference to the handle 24, and is inserted into the tubing end 118, which generally has an internal burr as the result of action of a tubing cutter (not shown), engaging the edge of the inner surface thereof. While the user holds the tubing 120 in the left hand, the handle 24 is rotated, again with a cranking motion, and the tubing end 118 is deburred.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A hand held tool for scarifying an inner cylindrical surface of a fitting and an outer cylindrical surface of a tubing end, comprising:
a body having first and second scarifying portions interconnected by an intermediate portion, said body having a front side and a rear side;
each of said scarifying portions having a respective inner surface scarifying brush projecting from said front side;
each of said scarifying portions having a cylindrical recess within said front side supporting a respective outer surface scarifying brush; and
a handle rotatably attached to said intermediate portion and projecting from said rear side, said handle having a rotational axis generally perpendicular to said rear side.

2. The tool of claim 1, wherein said inner surface scarifying brushes are of different diameters sized for scarifying fitting portions of two different diameters, respectively, and wherein said outer surface scarifying brushes are of different diameters sized for scarifying tubing ends of two different diameters, respectively.

3. The tool of claim 1, which further comprises a deburring blade attached to said body and having a deburring blade axis generally parallel to but spaced from the rotational axis of said handle.

4. The tool of claim 1, wherein
said intermediate portion of said body has a deburring recess extending between said front side and said rear side and large enough to clear a tubing end; and which further comprises
a deburring blade attached to said body, said deburring blade having a deburring blade axis generally parallel to but spaced from the rotational axis of said handle, and positioned within the deburring recess.

5. The tool of claim 4, wherein the deburring recess is generally semicylindrical.

6. The tool of claim 4, wherein the deburring blade axis is approximately midway between said outer surface scarifying brushes.

7. The tool of claim 1, wherein said body is elongated, has a body axis extending generally between said scarifying portions, and has a center of gravity approximately midway between said scarifying portions; and wherein
the rotational axis of said handle lies in a plane perpendicular to the body axis and is offset from the center of gravity in a direction perpendicular to the body axis;
whereby, when said tool is grasped by said handle with the axis of said handle generally horizontal, said body rotates by gravity to an orientation in which the body axis is approximately horizontal.

8. The tool of claim 7, which further comprises a boss on said rear side of said body coaxial with the rotational axis of said handle, said boss having a surface which the thumb of a user's hand can engage to serve as a stabilizing brake against rotation of said body relative to said handle.

9. The tool of claim 7, which further comprises a deburring blade attached to said body and having a deburring blade axis generally parallel to but spaced from the rotational axis of said handle in a direction perpendicular to the body axis.

10. A hand held tool for scarifying an inner cylindrical surface of a fitting, comprising:
a body having first and second scarifying portions interconnected by an intermediate portion, said body having a front side and a rear side;
each of said scarifying portions having a respective inner surface scarifying brush projecting from said front side; and
a handle rotatably attached to said intermediate portion and projecting from said rear side, said handle having a rotational axis generally perpendicular to said rear side.

11. The tool of claim 10, wherein said inner surface scarifying brushes are of different diameters sized for scarifying fitting portions of two different diameters, respectively.

12. The tool of claim 10, wherein said body is elongated, has a body axis extending generally through said scarifying portions, and has a center of gravity approximately midway between said scarifying portions; and wherein
the rotational axis of said handle lies in a plane perpendicular to the body axis and is offset from the center of gravity in a direction perpendicular to the body axis;
whereby, when said tool is grasped by said handle with the axis of said handle generally horizontal, said body rotates by gravity to an orientation in which the body axis is approximately horizontal.

13. The tool of claim 12, which further comprises a boss on said rear side of said body coaxial with the rotational axis of said handle, said boss having a surface which the thumb of a user's hand can engage to serve as a stabilizing brake against rotation of said body relative to said handle.

14. A hand held tool for scarifying an outer cylindrical surface of a tubing end, comprising:
a body having first and second scarifying portions interconnected by an intermediate portion, said body having a front side and a rear side;
each of said scarifying portions having a cylindrical recess within said front side supporting a respective outer surface scarifying brush; and
a handle rotatably attached to said intermediate portion and projecting from said rear side, said handle having a rotational axis generally perpendicular to said rear side.

15. The tool of claim 14, wherein said outer surface scarifying brushes are of different diameters sized for scarifying tubing ends of two different diameters, respectively.

16. The tool of claim 14, which further comprises a deburring blade attached to said body and having a deburring blade axis generally parallel to but spaced from the rotational axis of said handle.

17. The tool of claim 14, wherein
said intermediate portion of said body has a deburring recess extending between said front side and said rear side and large enough to clear a tubing end; and which further comprises
a deburring blade attached to said body, said deburring blade having a deburring blade axis generally parallel to but spaced from the rotational axis of said handle, and positioned within the deburring recess.

18. The tool of claim 17, wherein the deburring recess is generally semicylindrical.

19. The tool of claim 17, wherein the deburring blade axis is approximately midway between said outer surface scarifying brushes.

20. The tool of claim 16, wherein said body is elongated, has a body axis extending generally through said scarifying portions, and has a center of gravity approximately midway between said scarifying portions; and wherein
the rotational axis of said handle lies in a plane perpendicular to the body axis and is offset from the center of gravity in a direction perpendicular to the body axis;
whereby, when said tool is grasped by said handle with the axis of said handle generally horizontal, said body rotates by gravity to an orientation in which the body axis is approximately horizontal.

21. The tool of claim 20, which further comprises a boss on said rear side of said body coaxial with the rotational axis of said handle, said boss having a surface which the thumb of a user's hand can engage to serve as a stabilizing brake against rotation of said body relative to said handle.

22. The tool of claim 20, which further comprises a deburring blade attached to said body and having a deburring blade axis generally parallel to but spaced from the rotational axis of said handle in a direction perpendicular to the body axis.

23. A hand held tool for scarifying an inner cylindrical surface of a fitting and an outer cylindrical surface of a tubing end, comprising:
a body having a front side, a rear side, and first and second scarifying portions;
each of said scarifying portions having a respective inner surface scarifying brush projecting from said respective portion of said front side, said inner surface scarifying brushes having respective axes which are parallel to each other;
each of said scarifying portions having a cylindrical recess within a respective portion of said front side supporting a respective outer surface scarifying brush, said outer surface scarifying brushes having respective central axes which are parallel to each other and to the axes of said inner surface scarifying brushes; and
a handle rotatably attached to said body and projecting from said rear side, said handle having a rotational axis lying in a first rotational axis plane which is intermediate said inner surface scarifying brushes, perpendicular to a line between said inner surface scarifying brushes, and parallel to the axes of said outer surface scarifying brushes, and also lying in a second rotational axis plane which is intermediate said outer surface scarifying brushes, perpendicular to a line between said outer surface scarifying brushes, and parallel to the central axes of said outer surface scarifying brushes.

24. The tool of claim 23, wherein the first and second rotational axis planes are substantially coincident.

25. The tool of claim 23, wherein said inner surface scarifying brushes are of different diameters sized for scarifying fitting portions of two different diameters, respectively, and wherein said outer surface scarifying brushes are of different diameters sized for scarifying tubing ends of two different diameters, respectively.

26. The tool of claim 23, which further comprises a deburring blade attached to said body and having a deburring blade axis generally parallel to but spaced from the rotational axis of said handle.

27. The tool of claim 26, wherein the deburring blade axis is approximately midway between said outer surface scarifying brushes.

28. The tool of claim 23, wherein said body is elongated, has a body axis extending generally through said scarifying portions, and has a center of gravity approximately midway between said scarifying portions; and wherein
the rotational axis of said handle lies in a plane perpendicular to the body axis and is offset from the center of gravity in a direction perpendicular to the body axis;
whereby, when said tool is grasped by said handle with the axis of said handle generally horizontal, said body rotates by gravity to an orientation in which the body axis is approximately horizontal.

29. The tool of claim 28, wherein which further comprises a boss on said rear side of said body coaxial with the rotational axis of said handle, said boss having a surface which the thumb of a user hand can engage to serve as a stabilizing brake against rotation of said body relative to said handle.

30. The tool of claim 28, wherein which further comprises a deburring blade attached to said body and having a deburring blade axis generally parallel to but spaced from the rotational axis of said handle in a direction perpendicular to the body axis.
